(19) United States
(12) Patent Application Publication
(10) Pub. No.: US 2019/0277954 A1
(43) Pub. Date: Sep. 12, 2019

(54) ULTRASONIC TRANSDUCER

(71) Applicant: Robert Bosch GmbH, Stuttgart (DE)

(72) Inventors: Bayar Bayarsaikhan, Leonberg (DE); David Weidenfelder, Leonberg (DE)

(21) Appl. No.: 16/347,033

(22) PCT Filed: Sep. 12, 2017
(86) PCT No.: PCT/EP2017/072832

§ 371 Date: May 2, 2019

(30) Foreign Application Priority Data
Nov. 3, 2016 (DE) 10 2016 221 535.3

(51) Int. Cl. G01S 7/521; G10K 11/00; G10K 9/122; G10K 9/22; G01S 15/93

(52) U.S. Cl. CPC G01S 7/521; G10K 11/004; G01S 15/931; G10K 9/22; G10K 9/122

(57) ABSTRACT

An ultrasonic transducer is described as having a diaphragm cup that is connected to a housing by way of a preferably annular fastening element that radially surrounds the diaphragm cup at least indirectly at its outside diameter with reference to a longitudinal axis of the diaphragm cup.

### FIELD OF THE INVENTION

The present invention relates to an ultrasonic transducer.

### BACKGROUND INFORMATION

An ultrasonic transducer is described in German Published Patent Application No 10 2012 200 639. The known ultrasonic transducer is made up of several subassemblies or components connected to one another, in particular a diaphragm cup that is connected by way of a fastening element to a housing, with interposition of a decoupling ring made of elastic material. The diaphragm cup serves to receive or fasten a piezo element for exciting the diaphragm cup to vibrate in the ultrasonic region, while the housing, usually embodied as an injection-molded part, serves e.g. to receive a reception electronic system and to fasten the ultrasonic transducer to a bumper of a motor vehicle, the housing simultaneously constituting a connector plug by way of which the ultrasonic transducer is connectable to a counterpart plug connector of a wiring harness of the motor vehicle. The decoupling ring made of elastic material serves to minimize the transfer of vibrations from the diaphragm cup to the housing. With the ultrasonic transducer known from the aforesaid document, the annular fastening element is fastened on the outer circumference of the housing by way of a threaded connection. Also known instead of a threaded connection between the housing and the fastening element are snap-lock connections that secure or position the diaphragm cup on the housing by way of the fastening element. The fastening element disposed on the outer wall of the housing has the advantage that particularly simple fastening is enabled, since access to the fastening element is very good.

### SUMMARY

The ultrasonic transducer according to the present invention has the advantage that the fastening element is disposed in a manner particularly well protected from external (mechanical) influences. As a result, it is not necessary to configure the fastening element specifically with regard to maximum mechanical robustness. Depending on the embodiment of the connection between the fastening element and the housing, the disposition, provided according to the present invention, of the fastening element inside the housing furthermore at least impedes (unintentional) detachment of the fastening element and thus detachment of the diaphragm cup from the housing. Because the fastening element is disposed so as to be protected by the housing, the fastening element can furthermore be manufactured particularly inexpensively because of the less stringent requirements. Concretely, it is proposed according to the present invention that for positively or nonpositively engaged connection to the housing, the fastening element be disposed on the housing at least locally radially inside a receiving region for the fastening element. Such a configuration of the ultrasonic transducer makes it possible, for example, to connect the fastening element to the housing via a threaded connection as in the existing art recited previously, or else e.g. by way of a snap-lock connection.

In the interest of particularly simple installation in which, in contrast to a threaded connection, a minimum tightening torque or the like for the fastening element does not need to be established and monitored in order to ensure connection between the fastening element and the housing, provision is made that fastening of the fastening element on the housing is accomplished via a snap-lock connection that encompasses at least one snap-lock element that projects radially outward on the fastening element and interacts with an at least approximately counterpart snap-lock opening that is embodied in the region of the receiving region on the housing at least in the region of an inner wall of the receiving region. An “at least approximately counterpart snap-lock opening” is understood in this context to mean that the snap-lock element can be disposed in the snap-lock opening with a clearance in particular in a direction proceeding perpendicularly to an installation direction.

As a refinement of the proposal just recited, provision is made that the snap-lock opening is embodied as a passthrough opening. A passthrough opening has the advantage that access to the snap-lock opening from the outer side of the housing is possible, so that on the one hand visual monitoring with regard to configuration of the snap-lock connection, and on the other hand particularly simple deinstallation, are made possible. Especially if the snap-lock element does not protrude beyond the passthrough opening on the outer side of the housing, mechanical protection of the snap-lock element is furthermore ensured by the outer wall of the housing.

In order to release the snap-lock connection again or to limit the installation forces required when establishing the snap-lock connection, provision is made that the at least one snap-lock element is embodied as an elastically deformable or movable snap-lock element.

In a further embodiment that is preferred in terms of design and makes possible a stepless transition to the housing with particular protection for the fastening element, provision is made that the fastening element has, on the side facing away from the housing in a longitudinal direction, an outer contour that adapts to the outer contour of the housing and terminates flush therewith; and that an end surface of the fastening element facing away from the housing terminates flush with an end surface of the receiving region.

In order to achieve sealing of the receiving region by the decoupling ring when a decoupling ring is used, provision is made that the fastening element has a radially inward-projecting crush portion that interacts with the elastically embodied decoupling ring disposed between the housing and the diaphragm cup.

A mechanically particularly robust snap-lock connection, which requires relatively little installation space when viewed in a longitudinal direction of the diaphragm cup, can be achieved if the at least one snap-lock element and the snap-lock opening interacting with the at least one snap-lock element are each embodied approximately rectangularly, the principal direction of extent of the snap-lock element and of the snap-lock opening proceeding perpendicularly to the longitudinal axis of the diaphragm cup.

In order to dispose the fastening element in a defined rotation-angle position with respect to the housing, provision is made, in particular in the context of an embodiment in which the snap-lock element is disposed with a clearance with reference to the rotation-angle position with respect to the snap-lock opening, that at least one centering means is embodied respectively on the fastening element and on the housing, the centering means interacting and positioning the fastening element in a defined angular position with respect to the housing.

### BRIEF DESCRIPTION OF THE DRAWINGS

FIG. 1 is a simplified longitudinal section through an ultrasonic transducer.

FIG. 2 is a perspective view of a housing and of a fastening element as used in the ultrasonic transducer in accordance with FIG. 1.

FIGS. 3 and 4 are depictions, each as simplified longitudinal sections, to explain different possibilities for installing the ultrasonic transducer in accordance with FIG. 1.

### DETAILED DESCRIPTION

Elements that are the same or have the same function are labeled in the Figures with the same reference numbers.

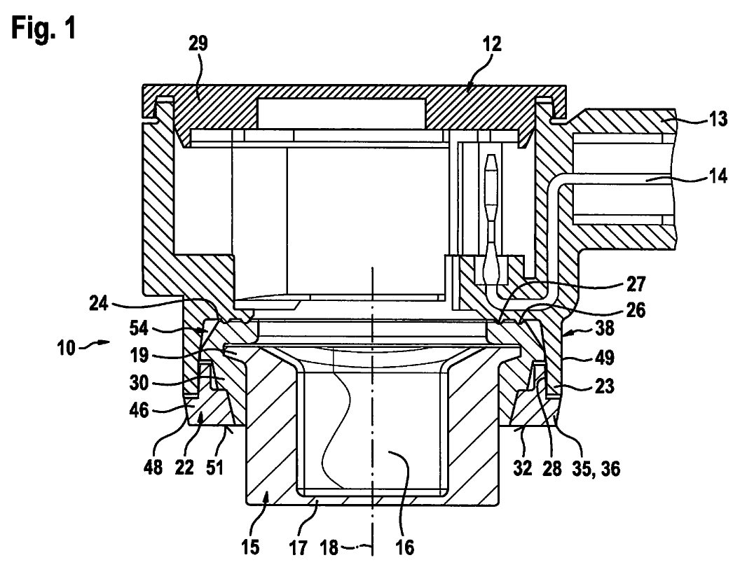

FIG. 1 depicts, in highly simplified fashion, an ultrasonic transducer 10 that serves as a constituent of a driver assistance system in a motor vehicle.

In particular, ultrasonic transducer 10 is disposed or fastened in the region of a bumper of the motor vehicle and serves to measure the distance to objects, for example during parking maneuvers. As is known per se, acoustic waves in the ultrasonic region are generated by ultrasonic transducer 10 and reflected from the object, and the distance between ultrasonic transducer 10 and the detected object is inferred from the signal transit time of the acoustic waves. Be it noted additionally that several such ultrasonic transducers 10, for example four ultrasonic transducers 10 or six ultrasonic transducers 10, are usually disposed, spaced apart from one another, in the region of a bumper.

Ultrasonic transducer 10 depicted in the Figures has a housing 12 that is made of plastic and encloses, in the region of a connector plug 13, several electrical plug connector lugs 14. Plug connector lugs 14 and connector plug 13 are connectable to a counterpart plug connector (not depicted) of a wiring harness of the motor vehicle. Housing 12 furthermore serves to fasten ultrasonic transducer 10 in the region of the aforementioned bumper, for which an additional fastening element or the like (not depicted in the Figures) can be provided as applicable. Provision is made in particular to dispose ultrasonic transducer 10 or housing 12 in a defined position in the bumper in order to achieve desired emission characteristics for the acoustic waves.

Housing 12 is connected to a diaphragm cup 15 that is made of metal and is configured by deep drawing or cold extrusion. Diaphragm cup 15 has a recess 16 in the shape of a blind hole, there being disposed in a bottom region 17 of recess 16 an acoustic transducer element (not depicted), in particular in the form of a piezo element, which is operatively connected to diaphragm cup 15 or bottom region 17. Diaphragm cup 15 furthermore has, perpendicularly to a longitudinal axis 18 of diaphragm cup 15 on the side facing toward housing 12, a radially encircling outward-projecting holding flange 19.

Diaphragm cup 15 is received, on the side facing toward holding flange 19, in a receiving region 22 of housing 12. Receiving region 22, which is delimited by a radially encircling housing wall 23, furthermore has, in the region of a radially encircling axial stop surface 24 disposed perpendicularly to longitudinal axis 18, several elevations 26, 27 that can likewise be disposed in particular radially encirclingly around longitudinal axis 18 at a different spacing from longitudinal axis 18. In the exemplifying embodiment depicted, inner wall 28 of housing wall 23 is embodied slightly conically with reference to longitudinal axis 18, in such a way that the inside diameter of receiving region 22 decreases toward a housing cover 29 of housing 12.

Receiving region 22 radially encompasses diaphragm cup 15 with interposition of a decoupling ring 30 made of elastic material. Decoupling ring 30, made in particular of an elastomer, is disposed axially between holding flange 19 of diaphragm cup 15 and stop surface 24 of receiving region 22. In the exemplifying embodiment depicted, decoupling ring 30 furthermore terminates flush with an end surface 32 of receiving region 22 which delimits receiving region 22. It is essential that the disposition of decoupling ring 30 be such that no immediate, i.e. direct, contact takes place between diaphragm cup 15 and housing 12. The axial fastening, taking place in a defined rotation-angle position with respect to longitudinal axis 18, of diaphragm cup 15 on housing 12 is effected by way of a fastening element 35 in the form of a retaining ring 36.

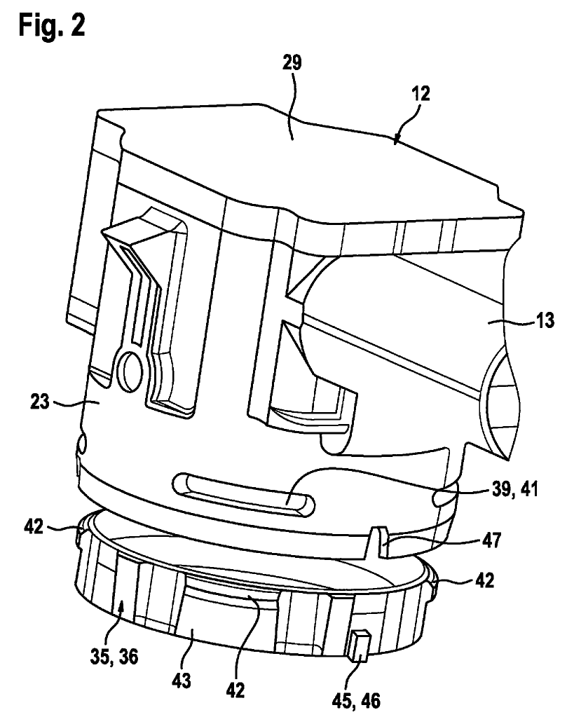

Fastening element 35 is embodied in particular in the form of a injection-molded plastic part, and is connected to housing 12 of ultrasonic transducer 10 by way of a snap-lock connection 38. In the exemplifying embodiment depicted, snap-lock connection 38 encompasses on receiving region 22 of housing 12 several snap-lock openings 39 that encircle radially with reference to longitudinal axis 18 and are arranged preferably at equal angular spacings from one another. In the exemplifying embodiment depicted, snap-lock openings 39 are embodied in the form of elongated-hole-shaped passthrough openings 41 and have a principal direction of extent which is oriented perpendicularly to longitudinal axis 18. Snap-lock openings 39 respectively interact with snap-lock elements 42 embodied on retaining ring 36, which are evident only in FIG. 2. Snap-lock elements 42 are shaped integrally onto retaining ring 36 by way of a tab-like connecting element 43 and project radially outward with reference to longitudinal axis 18. Snap-lock elements 42 are disposed to be elastically depressable or movable radially inward by way of connecting elements 43. In particular, the shape of snap-lock elements 42 is adapted to the shape of snap-lock openings 39, i.e. so that they are embodied approximately rectangularly and have a principal direction of extent that proceeds perpendicularly to longitudinal axis 18. The length of snap-lock elements 42 in a circumferential direction can be somewhat less than the corresponding length of snap-lock openings 39, so that a (slight) rotation-angle clearance can exist between snap-lock openings 39 and snap-lock elements 42.

Centering means 45 are furthermore provided for positionally correct orientation of retaining ring 36 on receiving region 22 of housing 12. Centering means 45 encompass, by way of example, a cam 46 that protrudes from the outer wall of retaining ring 36 and engages into a counterpart cutout 47 in receiving region 22.

As is evident in particular from FIG. 1, the slightly conically embodied outer contour 48 of retaining ring 36 is adapted to outer contour 49 of housing wall 23 in such a way that outer contour 48 transitions flush into outer contour 49.

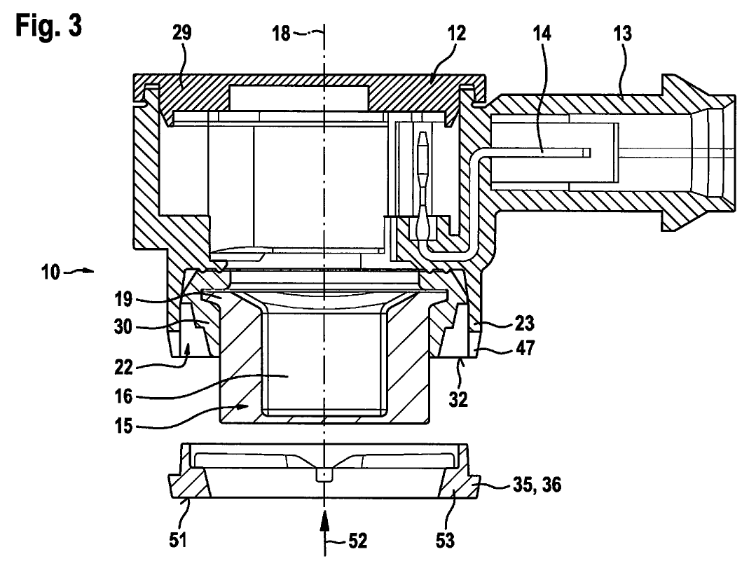

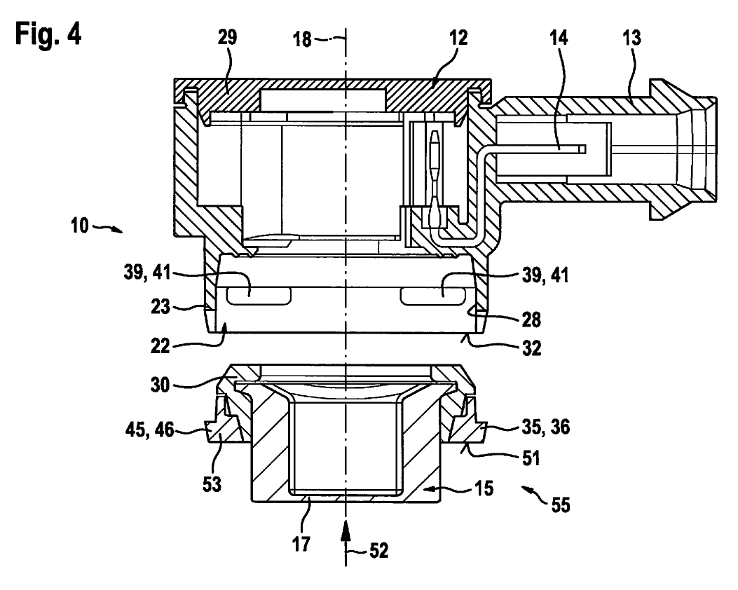

Retaining ring 36 has a (lower) end surface 51 that, when retaining ring 36 is installed, terminates flush with end surface 32 of receiving region 22, the installation direction of retaining ring 36 relative to housing 12 being identified by arrow 52 (FIGS. 3, 4). Retaining ring 36 has an inward-projecting encircling crush portion 53 that serves for abutment of decoupling ring 30 against the outer wall of diaphragm cup 15. As is evident from FIG. 1, a cavity 54 for receiving decoupling ring 30 is furthermore embodied in housing 12 between holding flange 19 of diaphragm cup 15 and stop surface 24 of receiving 22.

Installation of diaphragm cup 15, of decoupling ring 30, and of retaining ring 36 on housing 12 can be effected in various ways, as depicted in FIGS. 3 and 4. FIG. 3 depicts the situation in which diaphragm cup 15 together with decoupling ring 30 is already disposed or positioned within receiving region 22 of housing 12. In this case retaining ring 36 is then moved out of the position depicted in FIG. 3 in the direction of arrow 52 in order to create snap-lock connection 38, corresponding to FIG. 1, between retaining ring 36 and housing 12.

FIG. 4, conversely, depicts the situation in which diaphragm cup 15 is preassembled to decoupling ring 30 and retaining ring 36. Subassembly 55 thereby constituted is then introduced into receiving region 22 of housing 12 in the direction of arrow 52, snap-lock connection 38 being constituted.

Ultrasonic transducer 10 that has been described thus far, and fastening element 35, can be varied or modified in a multiplicity of ways without deviating from the concept of the invention. All that is essential is that fastening element 35 or retaining ring 36 be received at least locally radially inside housing 12 of ultrasonic transducer 10.

1.-10. (canceled)

11. An ultrasonic transducer, comprising:
a housing;
a fastening element; and
a diaphragm cup that is connected to the housing by way of the fastening element, wherein:
the fastening element radially surrounds the diaphragm cup at least indirectly at an outside diameter of the diaphragm cup with reference to a longitudinal axis of the diaphragm cup, and
for a positively or nonpositively engaged connection to the housing, the fastening element is disposed in the housing at least locally radially inside a receiving region for the fastening element.

12. The ultrasonic transducer as recited in claim 11, wherein the fastening element is annular.

13. The ultrasonic transducer as recited in claim 11, wherein:
the fastening element is fastened on the housing by way of a snap-lock connection that includes at least one snap-lock element that projects radially outward on the fastening element and interacts with an at least approximately counterpart snap-lock opening that is embodied in the receiving region at least in a region of an inner wall of the receiving region.

14. The ultrasonic transducer as recited in claim 13, wherein the snap-lock opening includes a passthrough opening.

15. The ultrasonic transducer as recited in claim 13, wherein the at least one snap- lock element includes an elastically movable snap-lock element.

16. The ultrasonic transducer as recited in claim 11, wherein:
the fastening element has, on a side facing away from the housing in a longitudinal direction, an outer contour adapted to an outer contour of the housing and proceeds flush therewith, and
an end surface of the fastening element facing away from the housing terminates flush with an end surface of the receiving region.

17. The ultrasonic transducer as recited in claim 11, further comprising:
an elastic decoupling ring disposed between the housing and the diaphragm cup, wherein the fastening element has a radially inward-projecting crush portion that interacts with the elastic decoupling ring.

18. The ultrasonic transducer as recited in claim 13, wherein the at least one snap- lock element and the snap-lock opening interacting with the at least one snap-lock element are each approximately rectangular, a principal direction of extent of the snap-lock opening and the at least one snap-lock element proceeding perpendicularly to the longitudinal axis of the diaphragm cup.

19. The ultrasonic transducer as recited in claim 11, further comprising:
a first centering element disposed on the fastening element; and
a second centering element disposed on the housing, wherein the first and second centering elements interact with and position the fastening element in a defined angular position with respect to the housing.

20. The ultrasonic transducer as recited in claim 11, wherein a cavity is disposed between a radially encircling holding flange of the diaphragm cup and a radially encircling stop region of the receiving region.

21. The ultrasonic transducer as recited in claim 11, wherein the fastening element is as an injection-molded plastic part.
